(19) United States
(12) Patent Application Publication
(10) Pub. No.: US 2014/0030493 A1
(43) Pub. Date: Jan. 30, 2014

(54) TWO-PACK PLASTISOL INK COMPOSITIONS FOR SCREEN PRINTING OF TEXTILES

(71) Applicants: James M. Hurley, Atlanta, GA (US); Frank S. Burkus, Cumming, GA (US); Erik M. Saly, Kennesaw, GA (US); J. Kevin Seagraves, Canton, GA (US)

(72) Inventors: James M. Hurley, Atlanta, GA (US); Frank S. Burkus, Cumming, GA (US); Erik M. Saly, Kennesaw, GA (US); J. Kevin Seagraves, Canton, GA (US)

(73) Assignee: POLYONE CORPORATION, Avon Lake, OH (US)

(21) Appl. No.: 14/111,422

(22) PCT Filed: May 1, 2012
(86) PCT No.: PCT/US12/35985

§ 371 Date: Oct. 11, 2013

Related U.S. Application Data
(60) Provisional application No. 61/481,707, filed on May 2, 2011.

(51) Int. Cl. C09D 11/10

(52) U.S. Cl. CPC C09D 11/107
USPC 428/195.1; 524/560; 524/293; 524/287; 524/292

(57) ABSTRACT

Plastisol ink compositions are disclosed containing (meth)acrylate polymer, non-phthalate ester plasticizers, and optionally, pigment, filler, thixotropic agent, and other additives. The plasticizers are separated into lower and higher solvating plasticizers, and the composition for handling and storage is separated into two masterbatches with the (meth)acrylate polymer mixed with the lower solvating plasticizer. The plastisol can be used an ink of various colors for use in application to textiles. The plastisol ink compositions avoid polyvinyl chloride polymer resins and phthalate plasticizers conventionally employed in plastisol inks.

### CLAIM OF PRIORITY

This application claims priority from U.S. Provisional Patent Application Ser. No. 61/481,707 bearing Attorney Docket Number 12011008 and filed on May 2, 2011, which is incorporated by reference.

### FIELD OF THE INVENTION

This application concerns plastisol ink compositions that are prepared from two different packages of plasticizer-containing materials.

### BACKGROUND OF THE INVENTION

Plastisol ink compositions are well known for their ability to be screen-printed or otherwise applied to textiles and then be heated to form graphics and other images on the textiles. Most common among these imaged textiles are T-shirts with the image of famous entertainers, college names, witty sayings, etc.

The plastisol ink composition is often called a plastisol ink, because the means of application utilizes the fluid properties of the plastisol before heating and/or pressure causes the base resin in the plastisol to cure into a solid. Historically, most plastisols were a combination of polyvinyl chloride (PVC) resin particles dispersed in and swelled by phthalate-based plasticizers.

Wilflex brand plastisol inks from PolyOne Corporation are world renown for their quality and variety of color products.

One-pack PVC plastisol ink is widely used in screen printing operation to adorn textiles, principally tee shirts, with bright and attractive graphical images (logos, team names, etc.). However, due to environmental and health and safety concerns, the composition of these inks is under increasing regulatory scrutiny.

It is therefore of great interest to find alternative compositions which perform as well as PVC plastisols, but are of lesser health and environmental risks.

The use of acrylic resins in place of PVC, together with non-phthalate plasticizers such as adipate esters, citrates or benzoate esters is especially attractive and has been extensively researched. Nonetheless, it has not yet been possible to identify suitable combinations of materials which will yield a non-phthalate, non-PVC plastisol ink with a good balance of properties, i.e. storage stability, fast gelation and cure, soft-hand, Crock resistance, wash fastness, tensile elongation, scratch resistance, etc.

For example, a polymethyl methacrylate (PMMA) homopolymer (such as Degalan 4944 from Evonik Industries, AG), when blended with 150 parts per hundred of resin (phr) of a sufficiently high-solvating plasticizer blend such as acetyl triethyl citrate (e.g., Citroflex A4 from Vertellus), produces a strong, elastic film with no exudation. However, this composition has poor storage stability at elevated (115° F./46° C.) temperatures and gels within days. On the other hand, combining Degalan 4944 with low-solvating plasticizers (e.g., diocty terephthalate (Eastman 168 plasticizer from Eastman Chemical) or Hexamoll DINCH plasticizer from BASF) produces pastes with excellent storage stability, but poor mechanical properties and exudation in the cured film. To address this problem, a number of patents and patent applications propose the use of acrylic core-shell polymers, namely: U.S. Pat. No. 4,199,486 (Boessler et al.); U.S. Pat. No. 5,324,762 (Overend et al.); U.S. Pat. No. 6,355,712 (Schultes et al.); U.S. Pat. No. 6,433,048 (Kasai); and US2010/0069566 (Mae).

These patents and published patent applications teach that a core-shell structure is effective in improving the storage stability of an acrylic plastisol paste and avoiding exudation, whereby the core is an acrylic copolymer and the shell is (predominantly) a PMMA homopolymer. Unfortunately, improvements in storage stability and reduced exudation tendency of the core-shell resins over PMMA homopolymer are usually accompanied by a decrease in physical properties such as tensile strength and scratch resistance in the cured material. As discussed by G. Wang et. al: “Preparation and Properties of Novel Plastisols Based on Acrylic Core-Shell Lattices,” Colloid. Polym. Sci. 283, pp. 98 (2004): incorporation of a high content of MMA into the core materials of core-shell resins results in an increase of the T_{g} and the mechanical properties, as compared to a core that contains large amounts of e.g. butyl methacrylate copolymer.

A rather different approach is discussed in U.S. Pat. No. 6,495,626 (Overend et al.) which discloses the use of a blend of a plasticizer incompatible acrylic resin with a plasticizer compatible resin. Despite improvements, the storage stability and physical properties of these compositions remain unsatisfactory.

To address the poor strength, elongation and durability issues of plastisols made with acrylic core-shell resins, several persons have described interpenetrating polymer networks (IPNs), made by adding reactive blocked isocyanate-functional pre-polymers with suitable curing agents into the plastisol paste. These materials then co-cure to produce a dispersed polyurethane or polyurea phase. Examples of this approach are U.S. Pat. No. 6,916,869 Eto et al.; US2006/6173110 (Baba); and U.S. Pat. No. 7,332,539 (Nakayama et al.).

While the presence of an interpenetrating polyurethane or polyurea network in the acrylic plastisol may increase the strength, toughness etc. of the resulting cured film, the rate of cure of the blocked isocyanates is typically too slow for normal oven curing conditions (150° C., 1-2 minutes) used in the textile screen-printing industry, and so the full benefits are not achieved. In addition, blocked isocyanates pose health risks, because the blocking agents themselves are often irritants or can be carcinogenic. During elevated temperature cure cycles, they become free and either volatilize (an inhalation hazard), or remain in the film layer (a skin contact hazard).

An interesting new approach to these problems in the industry has been described in U.S. Pat. No. 7,622,525 (Ukai et al.). In this patent, Ukai et al. forego the requirement of a one-pack system and instead, the acrylic plastisol components are split into two storage-stable parts:

Part A (a mixture of the thermoplastic resin in a poor solvating plasticizer along with dicyandiamide curing agent), and

Part B (a mixture of a strong solvating plasticizer along with a very strongly solvating acrylic or methacrylic monomer and fillers).

Parts A and B are blended prior to use to create a fast reacting and adherent coating. This approach helps solve the storage stability problem, but the composition, after blending, gels too quickly at room temperature (0.5-60 min) for screen printing applications. In addition, the acrylic or methacrylic monomers used are volatile irritants with a strongly objectionable odor.

Therefore, the industry still lacks a solution to the deficiencies of the various prior approaches to a non-PVC/non-phthalate printing ink which meets all the requirements for screen-printing of textiles.

### SUMMARY OF THE INVENTION

What the art needs is a plastisol ink that is essentially free of vinyl halide and phthalate plasticizer which utilizes storage in two different component parts, also called a “two-pack” system. Both consumers and marketers or printers of imaged textile products prefer compositions that do not include vinyl halide polymer resins or phthalate plasticizers for them.

“Essentially free” means that there is no intention to include any vinyl halide material or phthalate plasticizer material in the plastisol ink compositions.

The two-pack system of the invention utilizes different non-phthalate plasticizers in each pack. The two different non-phthalate plasticizers are selected based on their respective Hildebrand Solubility Parameters (HSP) expressed as δ for substance B in the following equation (1):

$${δ}_{B} = {( \frac{{Δ}_{vap} {E}_{m , B}}{{V}_{m , B}} )}^{1 / 2} \qquad ( 1 )$$

where ΔᵥₐₚE_{m,B} is the molar energy of vaporization at zero pressure and V_{m,B} is the molar volume. The HSP predicts the solubility of nonelectrolytes (including polymers) in a given solvent.

The pack containing the lower HSP plasticizer contains acrylic resin. The pack containing the higher HSP plasticizer contains no acrylic resin.

One aspect of the present invention are plastisol ink compositions that are essentially free of polyvinyl halides and phthalate plasticizers made from two different masterbatches, comprising (a) a first masterbatch of acrylic resin and at least one non-phthalate ester plasticizer having a weighted average Hillebrand Solubility Parameter of between about 17.8 and about 19.2 (J cm⁻³)^{1/2}; and (b) a second masterbatch of at least one non-phthalate plasticizer having a weighted average Hillebrand Solubility Parameter of between about 19.6 and about 20.2 (J cm⁻³)^{1/2}; wherein after the first masterbatch and the second masterbatch have been blended together, the plastisol ink composition has a gelation temperature of from about 74° C. to about 84° C. and a useful shelf-life of at least about 24 hours.

The gelation temperature is determined using a controlled stress rheometer. The plastisol is placed between 20 mm parallel plates and heated from 30° C. to 110° C. at a rate of 3° C./min, using an oscillatory frequency of 1 Hz (6.2832 rad/sec) and a torque of 1000 micro Nm. The gel point is taken as the G′/G″ cross-over, as described below.

A feature of the present invention is that the plastisol ink compositions of the present invention have processing properties comparable to polyvinyl halide-based plastisol ink compositions without the presence of the polyvinyl halides.

An advantage of the present invention is that the plastisol ink compositions can be used as inks for placing, such as by screen-printing, graphics and other images on textiles in virtually the same manner as conventional polyvinyl halide-based plastisol inks.

Thus, the two-pack acrylic plastisol ink composition of the invention comprises a Part A and a Part B, such that:

1) Part A contains an acrylic resin dispersed in at least one plasticizer possessing a low-to-moderate weighted average solubility parameter δ_{A}, and

2) Part B contains at least one plasticizer possessing a high weighted average solubility parameter δ_{B} along with, optionally, rheological agents, fillers, pigments, etc., but containing no resin.

Individually, these two Parts exhibit exceptional rheological storage stability, exceeding several months, but separately do not produce a thermosetting film of acceptable quality. When combined, however, the blend yields a resin, dispersed in a “synergistic” plasticizer mixture, which is optimally compatible with the thermoplastic resin used.

For these purposes, “synergistic” means the “effective” solubility parameter of the blend is higher than that expected from the two individual plasticizers using the Rule of Mixtures, as evidenced by a low gelation temperature.

When screen-printed onto textiles and then thermally cured, the performance of this composition is similar to PVC plastisol in relevant performance criteria like Crock fastness, wash fastness, soft hand, high elongation and scratch resistance, In addition, the blended material maintains a “screen-life” (i.e., a time in which the plastisol maintains a viscosity which is acceptably low for screen printing) from several hours to several days, which contributes to the ease of use.

Other aspects of the invention will become apparent from a description of the embodiments.

### EMBODIMENTS OF THE INVENTION

Use of Hillebrand Solubility Parameter Principles

The selection of resin and both plasticizers depends on an understanding of the theory of solubility parameters.

For a substance of low molecular weight such as a plasticizer, the value of the solubility parameter can be estimated most reliably from the enthalpy of vaporization and the molar volume. Alternatively, a value can be estimated from the solubility of a solid in a series of solvents of known solubility parameter.

For a polymer, it is usually taken to be the value of the solubility parameter of the solvent producing the solution with maximum intrinsic viscosity or maximum swelling of a network of the polymer. The SI units are Pa^{1/2}, but units used frequently are (μPa)^{1/2}=(J cm⁻³)^{1/2}. For additional explanation, one can refer to Hildebrand et al., The Solubility of Nonelectrolytes, 3rd ed., Reinhold Publishing (1950); Dover Publications (1964), Chap. VII, p. 129; Chap. XXIII.

When experimental data are lacking, it is convenient to calculate the solubility parameter using additive group contribution methods. Several authors including Small, Hoy, Fedors and Van Krevelen have proposed lists of contributions for various chemical groups. For additional explanation, one can refer to Van Krevelen, Properties of Polymers, 3^{rd} ed., Ch. 7: “Cohesive Properties and Solubility”, pp. 189 et seq., Elsevier, Amsterdam (1997).

For example, using the average of the methods of Hoy and Van Krevelen, the solubility parameters of several representative plasticizers are provided in Table 1.

TABLE 1
Plasticizer HSPs

| Plasticizer* | δ (Hoy) | δ (H-vK) | δ_{average} |
|---|---|---|---|
| Dioctyl sebacate | 18.41 | 16.98 | 17.70 |
| DINCH (1,2-cyclohexane dicarboxylic | 18.27 | 17.26 | 17.76 |
| acid diisononyl ester) | | | |
| Dioctyl adipate | 18.6 | 17.09 | 17.84 |
| Diisodecyl phthalate | 18.85 | 17.52 | 18.19 |
| Isodecyl benzoate | 19.21 | 17.67 | 18.44 |
| Diisoheptyl phthalate | 19.27 | 17.75 | 18.51 |
| Dioctyl terephthalate | 19.33 | 17.76 | 18.54 |
| Benzyl-(2-ethylehexyl)-adipinate | 19.5 | 18 | 18.75 |
| Acetyl tributyl citrate | 19.9 | 18.23 | 19.06 |
| 1.3-pentanediol, 2.2.4-trimethyl-1,3- | 19.72 | 18.66 | 19.19 |
| dibenzoate (Benzoflex ™ 354) | | | |
| Dipropyleneglycol dibenzoate | 20.6 | 19.01 | 19.81 |
| Diethyleneglycol dibenzoate | 21.43 | 18.22 | 19.82 |
| Acetyl triethyl citrate | 20.82 | 19.3 | 20.06 |
| Butylbenzyl phthalate | 20.89 | 19.43 | 20.16 |

*Phthalate plasticizers shown for comparative purposes only.

The solubility parameters for a large number of resins are also available in the literature. In the case of a co-polymer, the solubility parameter can be estimated from a rule-of-mixtures calculation of the following equation (2):

$${δ}_{copolymer} = {\sum }_{i = 1}^{n} {ϕ}_{i} {δ}_{i} \qquad ( 2 )$$

where φᵢ=mole fraction of monomer (or homopolymer) i in the copolymer and δ=solubility parameter of monomer (or homopolymer) i in the copolymer.

Sample experimental values of HSPs for polymers deduced indirectly various types of experiments, as well as reasonable calculated values as obtained by J. Bicerano: Prediction of Polymer Properties, 2^{nd} edition, page 12, Marcel Dekker, NY (1996) are shown in Table 2

TABLE 2
Resin HSPs

| | δ, from | δ, | δ, |
|---|---|---|---|
| Resin | Experiments | Calculated | Preferred |
| PVC | 19.1-22.1 | 18.2-20.3 | 21.2 |
| PMMA | 18.6-26.3 | 18.0-23.1 | 20.2 |
| PnBMA | 17.9-18.7 | 17.6-18.4 | 19.1 |

The Flory-Huggins solution theory uses δ to determine whether a polymer A and a plasticizer B will be miscible by the following equation (3):

χ_{AB}=V_{ref}(δ_{A}−δ_{B})²/RT (3)

The Flory-Huggins interaction parameter χ_{AB} is a function of temperature (T); the mole fraction of each component, and the degree of polymerization. In this equation, V_{ref} is an appropriately chosen reference volume, and R is the gas constant. The blend miscibility is assumed to decrease with increasing χ_{AB}. For additional explanation, one can refer to Miller-Chou et al. “A Review of Polymer Dissolution,” Prog. Polym. Sci. 28, 1223-1270 (2003)].

Experimentally, the miscibility of a given resin and plasticizer can be determined from the solid-gel temperature Tₘ of a solid grain of resin in an excess of plasticizer. This approach has been used by several authors, such as Anagnostopoulos et. al.: Polymer-Dilutent Interactions I. A New Micromethod for Determining Polyvinyl Chloride-Diluent Interactions, J. Appl. Poly. Sci. 11, pp. 181-192 (1960) and Ramos-deValle and M. Gilbert: PVC/plasticizer compatibility. I: Evaluation. Plastics and Rubber Processing and Applications 13, pp. 151-156 (1990). For dilute solutions of PVC resin in excess plasticizer, there is a strong correlation between the solid-gel transition temp Tₘ and the Flory-Huggins Interaction Parameter χ_{AB}. In other words, T_{gel}=f(δᵣₑₛᵢₙ−δ_{plasticizer})². However, plastisol formulators are typically interested in more concentrated solution, where the ratio of solid resin to liquid plasticizer can range from 2:1 to 1:3. In such cases, a gelation transition temperature T_{gel} is conveniently determined using dynamic mechanical analysis. For additional explanation, one can refer to Daniels, “Optimization of Plastisol Processes by Dynamic Mechanical Analysis.” Journal of Vinyl and Additive Technology, 13: pp. 151-154 (2007) and [20] D. P. Owens: “Comparison of Plastisol Gelation Developed with a Strain Rheometer to Tensile Properties,” 2006 SPE RETEC

In concentrated solutions and commercial formulations, the gelation transition temperature T_{gel} will be affected by the DMA heating rate, the relative concentration of resin and plasticizers, as well as the presence of other components such as fillers, pigments etc. Nonetheless, published reports confirm a strong correlation between the interaction parameter χ_{AB} or (δᵣₑₛᵢₙ−δ_{plasticizer})² and the gelation temperature T_{gel}, particularly for phthalate plasticizers.

For plastisols in general and for plastisols for acrylic resins in particular, there exists an optimal solubility parameter range for the plasticizer used and, by extension, an optimal gelation temperature.

For example, if an acrylic resin and plasticizer are too compatible (=low T_{gel}), the storage stability of the plastisol paste will be poor, and the cured film with be very elastic, compliant, soft and tacky.

On the other hand, if the resin and plasticizer are too incompatible, then the storage stability will be good, but the resulting cured film will be stiff and brittle, with poor elongation and exudation of plasticizer upon standing.

Theoretically, an optimal plasticizer for an (meth)acrylic resin would lie in between these two extremes, resulting in a good overall balance of properties.

In the case of acrylic core-shell resins, the regions of polymer/plasticizer compatibility and polymer/plasticizer incompatibility are usually well separated. The reasons for this may be understood by considering a core-shell resin particle morphology, and Flory-Huggins theory. Assuming the core-shell resin is composed of equal amounts of PMMA (shell) and PBMA (core), the resin has an overall solubility parameter δ≈[0.5×19.1+0.5×20.2]=19.65. With a suitable plasticizer like dioctyl terephthalate (δ=18.54), the difference in solubility parameter between the plasticizer and the resin (average value) is relatively small: [19.65−18.54]=1.11, so that reasonably good film properties (soft with good strength and elongation, no exudation etc.) are obtained when the plastisol is cured at elevated temperatures. In addition, the PMMA shell resists solvatization by the dioctyl terephthalate plasticizer under storage conditions, thus providing good storage stability. Nonetheless, the two distinct components in the copolymer (PMMA shell and PBMA core) are themselves relatively incompatible, which may lead to micro segregation in the cured plastisol, and consequently poorer mechanical properties as compared to a pure homopolymer plastisol.

PMMA homopolymers generally require stronger solvating plasticizers, a consequence of the high solubility parameter of PMMA. Unfortunately, the regions of compatibility and incompatibility for such resins lie very close or even perhaps overlap. For this reason, it has proven difficult to formulate an acrylic homopolymer plastisol suitable for textile screen printing.

From this understanding of polymer/plasticizer interaction using HSP principles, this invention uses two different formulations in two different masterbatches before blending to form an acrylic plastisol ink.

Part A contains acrylic homopolymer dispersed in a poorly-solubilizing plasticizer. Part B contains a strongly-solubilizing plasticizer.

Either Part A or Part B can also contain mineral fillers such as calcium carbonate, moisture scavengers such as calcium oxide, pigments, dispersants, air-release agents, thixotropes etc.

When blended together, the mixture of the masterbatches yields an assembled plasticizer combination which is optimally suited to the acrylic polymer. Particularly, the mixtures are rheologically stable for several days to weeks, and the cured film exhibits excellent tensile strength, elongation with no tackiness or exudation.

Additionally, it is preferable to use plasticizer combinations for Part A and Part B that are synergistic, i.e. a blend of the two plasticizers which exhibits a significantly lower gelation temperature than would be expected from the two individual plasticizers, using a weighed average or rule-of-mixtures approach as seen in equation (4):

T_{gel,blend}=[φ₁×T_{gel-1}+φ₂×T_{gel-2}] (4)

φ₁ refers to the volume-fraction of plasticizer 1 in the plasticizer blend, φ₂ refers to the volume-fraction of plasticizer 2 in the blend, T_{gel-1} refers to the gelation temperature of a plastisol made using pure plasticizer 1 and T_{gel-2} refers to the gelation temperature of a plastisol made using pure plasticizer 2.

More preferably, the difference in solubility parameters between the strongly-solvating plasticizer of Part B and the weakly solvating plasticizer of Part A not be greater than about 2.0 J^{1/2} cm^{-3/2}.

Acrylic Resin

Resins for plastisols need to be compatible with the plasticizer used, and vice versa. Such resins need to have appropriate particle sizes for use in the mechanized application of inks to textiles. These two properties are common to conventional polyvinyl halides, which as dispersion resins are properly suited for being plasticized by phthalate materials.

Resins for the present invention need also to be essentially free of polyvinyl halides. The resins acceptable for use in the present invention include acrylic resins. Non-limiting examples of polymers based primarily on methylmethacrylate are: Degalan BM 310 (homopolymer from Evonik), Degalan 4944F (homopolymer from Evonik) and Dianal LP-3202 (core-shell copolymer, >95% PMMA from Mitsubishi Rayon, Japan).

The glass transition temperature (T_{g}) of the acrylic polymer resins can be above 90° C., preferable above 110° C. and most preferably above 120° C.

The number average molecular weight, Mn, of the polymer resin can be above 500,000, desirably above 2,000,000 and preferably above 4,000,000, as measured using high performance size exclusion chromatography, relative to polystyrene, with a polydispersity Mw/Mn between about 1.5 to about 3.0 and preferably from about 1.9 to about 2.6.

Acrylic resins can take a variety of forms as delivered from the manufacturer: bead polymers, pellets, granules, powders, spray dried emulsion polymers, etc. Before use, the particle size of the acrylic polymer resins can range from about 1 to about 100 μm and preferably from about 25 to about 45 μm. Preferably, the acrylic polymer resin is made by a spray-dried emulsion process.

A preferred acrylic resin is Degalan™ BM310 methacrylic homopolymer resin commercially available from Evonik Industries, AG having a HSP of around 21.2 (J/cm³)^{1/2}.

Lower HSP Plasticizers

Based on the above explanations and Table 1, for a (meth)acrylic homopolymer resin, the lower HSP plasticizers should have a weighted average HSP of between about 17.8 and 19.2. Using Table 1 above, any of them can be used so long as their weighted average falls within the range of between about 17.8 and 19.2

Preferably, the highest HSP plasticizer employed in Part A masterbatch is 2,2,4-trimethyl-1,3-pentanediol dibenzoate plasticizer marketed as Benzoflex 354 plasticizer by Eastman Chemical. Also preferably, it can be combined with isodecyl benzoate plasticizer marketed as Jayflex MB10 plasticizer by ExxonMobil, such that twice as much dibenzoate to benzoate yields a weighted average HSP of 18.94 for the combination of them in Part A.

If other non-phthalate plasticizers become available commercially, such as reFlex 100 bioplasticizer from PolyOne Corporation, then they can be added to the list as useful plasticizers so long as the weight average HSP of all plasticizers in Part A falls within about 18 to about 19.2.

Higher HSP Plasticizers

Table 1 makes clear that only specific plasticizers are suitable for Part B masterbatch which does not contain any acrylic resin. The three eligible candidates to have a HSP of at least about 19.6: diethylene glycol dibenzoate; dipropylene glycol dibenzoate; and acetyl triethyl citrate.

It is mathematically possible for minor amounts the other non-phthalate plasticizers listed in Table 1 to also be included in the Part B masterbatch so long as the weighted average HSP of all plasticizers in Part B exceeds about 19.6.

If other non-phthalate plasticizers become available commercially, then they can be added to the list as useful plasticizers so long as the weighted average HSP of all plasticizers in Part B exceeds about 19.6.

Pigment

Pigments are chosen for stability and color-fastness on the textile to be imaged. Pigments are particulate in form, which is a consideration on proper dispersion of such solids in the plastisol ink compositions of the present invention. Therefore, some care should be taken to provide adequate mixing of the ingredients of the plastisol ink composition.

Pigments are as varied as the colors of desired by the consumer. Pigments are well known to those of skill in the art, and are not different from pigments useful in the plastisol ink compositions containing polyvinyl halides and phthalates.

Of well known pigments, Table 3 shows representative examples of pigments which have been formulated with the plastisol ink compositions of the present invention.

TABLE 3
Commercial Pigments

| Pigment Brand Name | Source | Location |
|---|---|---|
| VR11 AURORA PINK | Dayglo | Cleveland, OH |
| VR13 ROCKET RED | Dayglo | Cleveland, OH |
| PIGMENT | | |
| ORANGE-RED FB-400 | United Mineral Co. | Korea |
| RED, FB-403 POWDER | United Mineral Co. | Korea |
| MP-PR5547 | Radiant | Richmond, CA |
| VR19 HORIZON BLUE | Dayglo | Cleveland, OH |
| RAD MP CH5510 | Radiant | Richmond, CA |
| TIONA R-CL4 | Millenium | Hunt Valley, MD |
| CAP 3422C ORANGE | Cappelle | Menen, Belgium |
| RAD LR1412 LITHOL | Magruder | Elizabeth, NJ |
| RUBINE | | |
| HOSTAPERM PINK E | Clariant | Basel, |
| | | Switzerland |
| HOSTAPERM VIOLET R | Clariant | Basel, |
| | | Switzerland |
| ULTRAMARINE BLUE | Whittaker, Clark & | South Plainfield, |
| | Daniels | NJ |
| HEUCO | Heucotech | Fairless Hills, |
| PHTHALOCYANATE | | PA |
| 264-8142 SUNFAST GREEN | Sun | Cinncinnati, OH |
| PERMANENT YELLOW | Clariant | Basel, |
| | | Switzerland |
| CABOT REGAL 400R | McCullough & | Charlotte, NC |
| | Benton | |
| HOSTAPERM PINK E | Clariant | Basel, |
| | | Switzerland |
| UHLICH YE-1400 YELLOW | Uhlich/Magruder | Elizabeth, NJ |
| TIOXIDE R-FC6 | Huntsman | Billingham, |
| | | England |

The pigment of particular concern is titanium dioxide (TiO₂) because white plastisols used as textile printing inks comprise approximately 50% of all plastisol ink used. Also white pigment must fulfill a number of additional technical requirements, e.g. good printing characteristics, opacity when printed on dark garments, the ability to “flash” (meaning to fuse quickly under heat lamps), etc.

The TiO₂ pigment should be of the rutile phase, with a mean particle size between 0.2 and 0.4 μm.

Filler

To adjust viscosity, the plastisol ink composition should also contain filler, such as precipitated calcium carbonate (CaCO₃). Desirably, the calcium carbonate should have a nearly spherical particle morphology with a median particle size of around 70 nm.

Thixotropic Agent

The plastisol ink composition (in particular an underbase white ink that will be printed on a dark garment) needs to include a thixotropic agent, in order that the shear stress vs. shear rate curve of the plastisol used as an ink, measured using an oscillatory frequency sweep at 25° C. with a cone and plate rheometer then data-transformed using the Cox-Merz Rule, conforms approximately to power-law fluid τ=K(τ)ⁿ where τ is the shear stress, K is the consistency of about 1.3×10⁵ Pa·s, γ is the shear rate and n (exponential factor) of about 0.134. In addition, it is important that the plastisol ink display a creep strain<0.05 when subjected to a static stress of 50 Pa in a creep test, using a cone and plate rheometer. When conforming to these requirements, the plastisol ink possesses a thick, buttery and “short” texture which allows for good printability, while at the same time producing printed images possessing good opacity and a soft, smooth “hand”.

If no thixotropic agent is present in plastisol inks of the present invention, then the printed garment will have a rough “hand.” The rough “hand” is caused by the unevenness of the surface deposit, primarily determined by surface roughness and coefficient of friction.

The thixotropic agent can be either a fumed silica such as Aerosil® 200 particles commercially available from Evonik Degussa or hydrogenated castor oil such as Thixcin® R oil commercially available from Elementis Specialties, or combinations thereof.

Optional Additives

A variety of additives known to those skilled in the art can be included in plastisol ink compositions of the present invention to increase processing or performance properties.

Non-limiting examples of additives include dispersants, lubricants, optical brighteners, puff matting agents, antioxidants, chemical and physical blowing agents, stabilizers, moisture scavengers, air release agents, oxidizers, reducers, and combinations thereof, etc.

These additives are commercially available from a wide variety of sources and are very well known by those skilled in the art desiring formulations that mix and process well (dispersants, lubricants, air release agents, etc.) as well as provide valuable performance properties (optical brighteners, puff matting agents, antioxidants, etc.)

Range of Ingredients

Table 4 shows acceptable, desirable, and preferred ranges of the ingredients identified above: resin, plasticizers, pigment, filler, thixotropic agent, and optional additives. The invention can be based on a blend comprising these ingredients, consisting essentially of these ingredients, or consisting of these ingredients.

TABLE 4
Range of Ingredients

| Ingredient | Acceptable | Desirable | Preferable |
|---|---|---|---|
| (Wt. %) | Range | Range | Range |
| (Meth)Acrylic | 10-35 | 20-35 | 25-40 |
| Polymer Resin | | | |
| Lower HSP | 20-45 | 30-45 | 30-40 |
| Plasticizer(s) | | | |
| Higher HSP | 10-25 | 15-25 | 15-20 |
| Plasticizer(s) | | | |
| Pigment(s) | 1-40 | 1.5-35 | 2-30 |
| CaCO₃ Filler | 5-20 | 8-17 | 10-15 |
| Thixotropic Agent | 0.5-10 | 1-7 | 2-5 |
| Additives | 0-40 | 5-30 | 10-20 |

The variation of pigment concentration depends greatly on how much pigment is needed to achieve the desired color. Some intense fluorescent colors require multiple pigments in significant concentrations. Also, pigment concentration is dependent on the location of color within colorspace, especially with respect to lightness/darkness.

The variation in additive concentration depends are which additives are being added and for what purpose. Those skilled in the art would not require undue experimentation to develop a collection of preferred additives and their concentrations to achieve flowable plastisol inks with lasting appearance on the textile.

The amount of ingredients identified in Table 4 does not necessarily indicate which masterbatch should include the ingredients other than the plasticizers and the resin. As stated previously, the Part A masterbatch contains the resin and the lower HSP plasticizer(s), while the Part B masterbatch contains the higher HSP plasticizers(s).

Because of the necessity of mixing intimately particulates (resin(s), pigment(s), certain additives) into the plasticizer, it is preferable to apportion the amount of plasticizer for introduction into a mixing chamber at various times. More preferably, for economy of color generation as known to those skilled in the art, one can develop a masterbatch of basis ingredients and then have a separate pigment concentrate(s) that are compatible with the masterbatch but do not require the inventory of having a full complement of colors of plastisol ink compositions, so long as the masterbatch can be mixed with a selected pigment concentrate at the appropriate time.

In respect of processing of plastisol ink compositions of the present invention, a feature of the invention is that the ingredients selected for the compositions unexpectedly provide very similar processing conditions for use by one skilled in the art of using polyvinyl halide plastisol ink compositions. Thus, it is very advantageous via the present invention to have an entirely new line of possible plastisol inks with virtually the same mechanics and techniques of use to make imaged graphics on textiles.

Method of preparing masterbatches and pigment concentrates are well known to those skilled in the art. The method of preparation of plastisol inks of this invention is identical to that of plastisol inks made from vinyl halides and phthalate esters, except that a two-pack masterbatch system is chosen for storage and handling prior to blending into the final plastisol combination. However, it has been found that use of three-roll milling aids in reducing particle size of the inks to improve delivery of the inks in the screen-printing process to the textile to be imaged.

### Usefulness of the Invention

Plastisol inks of the present invention provide comparable processing and performance as conventional plastisol inks containing polyvinyl halide resins and phthalate plasticizers, but are essentially free of them. For example, one can use the same squeegees, ovens, cure temperatures, dwell times, screens, emulsions, and clean up techniques as employed for polyvinyl chloride/phthalate plastisol inks.

With the exception of an Underbase white ink mentioned above, the viscosity of plastisol inks is acceptably from about 10,000 to about 200,000 centipoise, desirably from about 20,000 to about 180,000 cps and preferably from about 30,000 to about 120,000 cps when measured at 20 revolutions per minute on a Brookfield LVT rheometer. The inks are printable via screen printing techniques, including without limitation high speed automatic presses, manual printing, and high speed rotary printers.

Multiple plastisol inks can be used with different pigments in order to generate multi-colored image graphics according to techniques well known in the art.

It is an advantage of the invention that one can continue to use known techniques with new plastisol ink formulations that process and perform in a like manner to conventional plastisol ink formulations. Thus, mixers and printers are not required to learn new techniques, yet the screen-printed image graphics are made from new plastisol ink formulations.

Examples further demonstrate the utility of the invention.

### Examples

Example 1 (composed of Example 1A and Example 1B) and Comparative Examples A-G demonstrate that only a two-pack masterbatch system is suitable for a non-PVC, non-phthalate plastisol ink composition.

Table 5 shows the ingredients of Part A and Part B of Example 1 and then the result of their combination in a weight ratio of 80.70/19.30.

The Part A ingredients were blended together for 20 minutes using a KitchenAid stand mixer. The blend was subsequently milled using a laboratory three-roll mill.

The Part B ingredients were blended together utilizing a Dispermat high-speed disperser equipped with a dissolver disc impeller.

The two-pack Parts A and B masterbatches were stored separately and hand-mixed together prior to use.

TABLE 5

| | | | Wt. % in |
|---|---|---|---|
| | Parts in | Wt. % In | Example 1 |
| Part A Ingredients | Part A | Part A | Blend |
| Degalan BM310 acrylic | 100.00 | 31.90% | 25.52% |
| homopolymer resin | | | |
| (Evonik Industries, AG) | | | |
| HSP = 21.2 | | | |
| Benzoflex ® 354 2,2,4- | 105.18 | 33.55% | 26.84% |
| trimethyl-1,3-pentanediol | | | |
| dibenzoate plasticizer | | | |
| (Eastman Chemical Co.) | | | |
| HSP = 19.19 | | | |
| Jayflex ® MB 10 isodecyl | 50.82 | 16.21% | 12.97% |
| benzoate plasticizer | | | |
| (ExxonMobil Chemical | | | |
| Co.) HSP = 18.44 | | | |
| Ultra-pflex ® precipitated | 32.2 | 10.27% | 8.22% |
| calcium carbonate | | | |
| (Specialty Minerals) | | | |
| MicroCal OF325 calcium | 17.8 | 5.68% | 4.54% |
| oxide moisture scavenger | | | |
| (Mississippi Lime) | | | |
| Disperplast ® 1150 | 1.5 | 0.48% | 0.38% |
| dispersing additive (BYK- | | | |
| Chemie) | | | |
| Expancel ® 091 | 2 | 0.64 | 0.51% |
| (AkzoNobel) | | | |
| Aerosil ® A-200 fumed | 4 | 1.27% | 1.02% |
| silica thixotrope (Evonik | | | |
| Industries, AG) | | | |
| Total | 313.5 | 100.00% | 80.00% |

| | | | Wt. % in |
|---|---|---|---|
| | Parts in | Wt. % In | Example 1 |
| Part B Ingredients | Part B | Part B | Blend |
| Benzoflex 9-88 plasticizer | 95 | 95.00% | 19.00% |
| (Dipropyleneglycol | | | |
| dibenzoate, Eastman | | | |
| Chemical Co.) HSP = 19.81 | | | |
| Aerosil ® A-200 fumed | 5 | 5.00% | 1.00% |
| silica thixotrope (Evonik | | | |
| Industries, AG) | | | |
| Total | 100 | 100.00% | 20.00% |

Table 6 shows the ingredients in Comparative Examples A-G, all “one-pack” in form. All ingredients of each Comparative Example were blended together for 20 minutes using a KitchenAid stand mixer. Each blend was subsequently milled using a laboratory three-roll mill.

Films for evaluation were fabricated by drawing down the wet plastisol onto a PTFE baking sheet using a 6-mil doctor blade, and then heat curing in an oven at 130° C. for 2 minutes. The film was cut into 5×20 cm strips for manually evaluating the tensile elongation. After 24 hrs, a compatibility test was performed by wiping the strip of cured plastisol with a cigarette paper, and examining it for traces of plasticizer.

The gel temperature of the composition was determined using an AR-1000N dynamic mechanical analyzer (TA Instruments) w/parallel plate geometry and a gap height=300 μm. The sample was heated at a rate of 3° C./min from 30 to 110° C. The test was performed in oscillatory mode, with an applied torque of 1000 micro N·m, and a frequency of 1 Hz. The gel temperature was taken as the G′/G″ crossover point.

The elevated-temperature storage stability was determined by placing a 25 g sample in 46° C. oven. The sample was manually probed at 12 hrs intervals to determine the time until the viscosity became so thick so as to preclude screen printing.

Table 7 shows the test results.

TABLE 6
Comparative Examples

| Ingredients (Wt. %) | A | B | C | D | E | F | G |
|---|---|---|---|---|---|---|---|
| Degalan BM310 acrylic homopolymer | 25.52% | 25.52% | 25.52% | 25.52% | 25.52% | 25.52% | 25.52% |
| resin (Evonik Industries, AG) HSP = 21.2 | | | | | | | |
| Benzoflex ® 354 2,2,4-trimethyl-1,3- | 58.81% | 0.00% | 0.00% | 0.00% | 26.84% | 39.21% | 0.00% |
| pentanediol dibenzoate plasticizer | | | | | | | |
| (Eastman Chemical Co.) HSP = 19.19 | | | | | | | |
| Jayflex ® MB10 isodecyl benzoate | 0.00% | 58.81% | 0.00% | 0.00% | 12.97% | 0.00% | 0.00% |
| plasticizer (ExxonMobil) HSP = 18.44 | | | | | | | |
| Benzoflex 9-88 plasticizer (Eastman | 0.00% | 0.00% | 58.81% | 0.00% | 19.00% | 19.60% | 44.11% |
| Chemical Co.) HSP = 19.81 | | | | | | | |
| Hexamoll DINCH plasticizer (BASF | 0.00% | 0.00% | 0.00% | 58.81% | 0.00% | 0.00% | 14.70% |
| Corp.) HSP = 17.76 | | | | | | | |
| Ultra-pflex ® precipitated calcium | 8.22% | 8.22% | 8.22% | 8.22% | 8.22% | 8.22% | 8.22% |
| carbonate (Specialty Minerals) | | | | | | | |
| MicroCal OF325 calcium oxide moisture | 4.54% | 4.54% | 4.54% | 4.54% | 4.54% | 4.54% | 4.54% |
| scavenger (Mississippi Lime) | | | | | | | |
| Expancel ® 091 (AkzoNobel) | 0.51% | 0.51% | 0.51% | 0.51% | 0.51% | 0.51% | 0.51% |
| Disperplast ® 1150 dispersing additive | 0.38% | 0.38% | 0.38% | 0.38% | 0.38% | 0.38% | 0.38% |
| (BYK-Chemie) | | | | | | | |
| Aerosil ® A-200 fumed silica thixotrope | 2.02% | 2.02% | 2.02% | 1.02% | 1.02% | 1.02% | 1.02% |
| (Evonik Industries, AG) | | | | | | | |
| Total | 100.00% | 100.00% | 100.00% | 100.00% | 100.00% | 100.00% | 100.00% |

TABLE 7
Test Results

| | | | 1A′ + 1B′ | | | | | | | |
|---|---|---|---|---|---|---|---|---|---|---|
| Properties | 1A′ | 1B′ | (80:20 blend) | A | B | C | D | E | F | G |
| HSP (J cm⁻³)^{1/2} | 18.69 | 19.8 | 19.19 | 19.19 | 18.44 | 19.81 | 17.76 | 19.22 | 19.39 | 19.3 |
| T(gel), ° C. | 89 | n/a | 84 | 93 | 123.8 | 74 | >130 | 83 | 85 | 82 |
| Storage stability, | 21 | n/a | 5 | 11 | >30 | 2 | >30 | 5 | 4 | 4 |
| 46° C. (days) | | | | | | | | | | |
| Tensile | 300 | n/a | >300 | >300 | ~20 | >300 | n/a (no | >300 | >300 | >300 |
| elongation (%) | | | | | | | film | | | |
| | | | | | | | formed) | | | |
| Tackiness | +/− | n/a | + | +/− | ++ | −− | n/a (no | + | − | ++ |
| | | | (minor) | | (none) | (very | film | (minor) | (tacky) | (none) |
| | | | | | | tacky) | formed) | | | |
| Exudation | − | n/a | ++ | − | −− | ++ | n/a (no | ++ | + | + |
| | (minor) | | (none) | (minor) | (bad) | (none) | film | (none) | (very | (very |
| | | | | | | | formed) | | minor) | minor) |

Examples 1A and 1B demonstrated that the individual masterbatches of the two-pack acrylic plastisol ink possess excellent storage stability, but do not, by themselves, produce an acceptable film. Example 1 [1A+1B] (80:20 blend) showed that when combined, the two-pack acrylic plastisol ink produces a cured film with most excellent properties (high tensile elongation, minimal tackiness, no exudation and a screen-life of >3 days).

Comparative Example A showed that a one-pack ink with a moderately-solvating plasticizer (Benzoflex™ 354), while exhibiting acceptable storage stability, exhibited some exudation and marginal elongation.

Comparative Example B shows that a one-pack ink with a poor solvating plasticizer (Jayflex™ 131) exhibited excellent storage stability and no tackiness, but excessive exudation and very poor mechanical properties.

Comparative Example C shows that a one-pack ink with a high solvating plasticizer (Benzoflex™ 9-88) exhibited poor storage stability, while producing a tacky film with high elongation and no exudation.

Comparative Example D showed that a one-pack ink with a very poor solvating plasticizer (Hexamoll™ DINCH) exhibited excellent storage stability, but failed to fuse and gel properly into a coherent film.

Comparative Example E showed that a one-pack ink with a blend of a high solvating plasticizer (Benzoflex™ 9-88), a moderately solvating plasticizer (Benzoflex™ 354) and a small amount of a poor solvating plasticizer (Jayflex™ MB 10) produced a film with optimal properties (high elongation, minimal tackiness, no exudation), but that, compared to the two-pack solution, the storage stability was poor. In addition, the plasticizer blend shows synergistic effects, because the T_{gel} in this Comparative Example E (83° C.) is lower than that expected from Comparative Examples B, C and D using the rule of mixtures, calculated to 93.7° C.

Comparative Example F showed that a one-pack ink with a blend of a high solvating plasticizer (Benzoflex™ 9-88) and a moderately solvating plasticizer (Benzoflex 354) produced a film with good properties, but that it exhibited some objectionable tackiness. As in the previous example, the storage stability was unsatisfactory.

Comparative Example G showed that a one-pack ink with a blend of a high solvating plasticizer (Benzoflex™ 9-88) and a very poor solvating plasticizer (Hexamoll™ DINCH) i.e. two plasticizers that are far apart in terms of their compatibility with the resin and widely disparate in terms of their solubility parameters, produced a film with acceptable film properties along with some exudation and poor stability.

The invention is not limited to the above embodiments. The claims follow.

What is claimed is:

1. A plastisol ink composition that is essentially free of polyvinyl halides and phthalate plasticizers made from two different masterbatches, comprising: a blend of
(a) a first masterbatch of acrylic resin and at least one non-phthalate ester plasticizer having a weighted average Hillebrand Solubility Parameter of between about 17.8 and about 19.2 (J cm-3)1/2; and
(b) a second masterbatch of at least one non-phthalate plasticizer having a weighted average Hillebrand Solubility Parameter of between about 19.6 and about 20.2 (J cm-3)1/2;
wherein after the first masterbatch and the second masterbatch have been blended together, the plastisol ink composition has a gelation temperature of from about 74° C. to about 84° C. and a useful shelf-life of at least about 24 hours.

2. The composition of claim 1, wherein the acrylic resin comprises methylmethacrylate homopolymer or methylmethacrylate-containing copolymer.

3. The composition of claim 1, wherein the acrylic resin has a glass transition temperature of more than about 90° C. and a number average molecular weight of more than about 500,000.

4. The composition of claim 1, wherein the acrylic resin has a particle size range of from about 1 to about 100 μm.

5. The composition of claim 1, wherein the acrylic resin has a polydispersity of between about 1.5 and 3.0.

6. The composition of claim 1, wherein the plasticizer of the first masterbatch is selected from the group consisting of 2,2,4-trimethyl-1,3-pentanediol dibenzoate, isodecyl benzoate, and combinations thereof.

7. The composition of claim 1, wherein the plasticizer of the second masterbatch is selected from the group consisting of diethylene glycol dibenzoate, dipropylene glycol dibenzoate, acetyl triethyl citrate, and combinations thereof.

8. The composition of claim 7, wherein the plasticizer of the second masterbatch further includes at least one other non-phthalate plasticizer so long as a weighted average Hillebrand Solubility Parameter of all plasticizers in the second masterbatch exceeds about 19.6.

9. The composition of claim 1, wherein the blend further comprises at least one pigment.

10. The composition of claim 9, wherein the pigment is titanium dioxide.

11. The composition of claim 9, wherein the blend further comprises filler and thixotropic agent.

12. The composition of claim 9, wherein the blend further comprises dispersants, lubricants, optical brighteners, puff matting agents, antioxidants, chemical and physical blowing agents, stabilizers, moisture scavengers, air release agents, oxidizers, reducers, or combinations thereof.

13. The composition of claim 11, wherein viscosity of the plastisol ink composition after blending range from about 10,000 to about 200,000.

14. A method of making the plastisol ink composition of claim 1, comprising the steps of:
(a) preparing the first masterbatch;
(b) preparing the second masterbatch;
(c) blending together the first masterbatch and the second masterbatch.

15. A textile article having an image graphic printed thereon from the plastisol of claim 1.

16. The textile article according to claim 15, wherein the article is a garment and wherein the image graphic of plastisol is applied by a screen-printing technique.
